(19) United States
(12) Patent Application Publication
(10) Pub. No.: US 2013/0244073 A1
(43) Pub. Date: Sep. 19, 2013

(54) NONAQUEOUS ELECTROLYTE BATTERY

(71) Applicants: Hideki Fujimoto, Ibaraki-shi (JP); Mitsuhiro Kishimi, Ibaraki-shi (JP)

(72) Inventors: Hideki Fujimoto, Ibaraki-shi (JP); Mitsuhiro Kishimi, Ibaraki-shi (JP)

(73) Assignee: HITACHI, LTD., Tokyo (JP)

(21) Appl. No.: 13/813,372

(22) PCT Filed: Mar. 14, 2012
(86) PCT No.: PCT/JP2012/056521

§ 371 Date: Jan. 30, 2013

(51) Int. Cl. H01M 10/04

(52) U.S. Cl. CPC H01M 10/0431
USPC 429/94

(57) ABSTRACT

It is an object of the present invention to provide a nonaqueous electrolyte battery in which a winding body is uniformly expanded, to thereby prevent undulation. A nonaqueous electrolyte battery (1) comprises a winding body (30) having a flattened shape, in which a positive electrode (31) and a negative electrode (32) are wound with separators (33, 34) interposed therebetween, and a negative electrode tab (36) joined to the negative electrode (32), extending in a winding axis direction of the winding body (30). The positive electrode (31) includes a positive electrode current collector (310) having a strip-like shape, a first positive electrode mixture layer (311) formed on one surface of the positive electrode current collector (310), and a second positive electrode mixture layer (312) formed on the other surface of the positive electrode current collector (310), and a winding trailing end portion (311b) of the first positive electrode mixture layer (311) is positioned on an inner side of the winding body (30) with respect to the negative electrode tab (36) in the width direction (x direction) and a winding trailing end portion (312b) of the second positive electrode mixture layer (312) is positioned on an outer side of the winding body (30) with respect to the negative electrode tab (36) in the width direction (x direction).

### TECHNICAL FIELD

The present invention relates to a nonaqueous electrolyte battery, and more particularly to a nonaqueous electrolyte battery comprising a flattened winding body.

### BACKGROUND ART

Conventionally, a structure of a nonaqueous electrolyte battery comprising a winding body in which a positive electrode and a negative electrode are wound with a separator interposed therebetween has been well known. Further, a structure of a flattened winding body which is used in order to achieve a square or thinned battery has been well known.

Japanese Patent Application Laid Open Gazette No. 2001-273881 relates to a battery comprising an electrode group which is wound, and more particularly to a battery comprising a wound electrode having a flattened shape, and discloses a technique to prevent internal short-circuit and provide a highly reliable battery.

Japanese Patent Application Laid Open Gazette No. 2005-222884 discloses a technique relating to a multilayer electrode battery which is capable of preventing short-circuit of a positive electrode and a negative electrode and averaging the thickness of a positive electrode lead terminal side and that of a negative electrode lead terminal side, to thereby ensure safety and high volumetric energy density.

Japanese Patent Application Laid Open Gazette No. 2007-26939 discloses a technique relating to a winding type battery having an electrode body which is flatly wound around a flat winding core, in which a winding end portion can be arranged at a desired position without any effect on battery properties or the like.

### DISCLOSURE OF INVENTION

### Problems to be Solved by the Invention

A positive electrode and a negative electrode used for a winding body are each formed by applying a mixture layer having an active material onto at least one surface of a strip-like current collector. For this reason, the winding body has a level difference in the thickness of the mixture layer at an application end of the mixture layer. Particularly in a case where the mixture layer is formed on both the surfaces of the current collector and the positions of the application ends of the mixture layers formed on both the surfaces are aligned, this level difference becomes larger.

In a nonaqueous electrolyte battery, charge and discharge are performed by giving and receiving guest ions between the positive electrode and the negative electrode. In a lithium-ion battery, for example, lithium ions are collected in the negative electrode during charge. The negative electrode is thereby expanded. With this expansion of the negative electrode, the whole winding body tends to be expanded. The winding body, however, is usually contained in a battery case with almost no clearance. For this reason, the winding body receives pressure from the battery case in a direction of suppressing the expansion.

In this case, if there is a level difference in the winding body as discussed above, the pressure received from the battery case is non-uniform on both sides of the level difference. When the winding body receives the non-uniform pressure, the negative electrode is non-uniformly expanded and there arises undulation in the winding body.

Further, inside the winding body, there are a positive electrode tab joined to the positive electrode and a negative electrode tab joined to the negative electrode. With the undulation of the winding body, there sometimes arises torsion in the current collector tab (the positive electrode tab or the negative electrode tab). In some cases, the torsion of the current collector tab cannot be resolved even if the nonaqueous electrolyte battery is discharged to remove the expansion of the winding body.

Such undulation of the winding body and torsion of the current collector tab deteriorate the battery properties of the nonaqueous electrolyte battery. Further, since the winding body is locally expanded against the pressure from the battery case, it is impossible to produce a thin battery having uniform thickness.

It is an object of the present invention to provide a nonaqueous electrolyte battery in which a winding body is uniformly expanded, to thereby prevent undulation.

According to the present invention, the nonaqueous electrolyte battery comprises a winding body having a flattened shape, in which a positive electrode and a negative electrode are wound with a separator interposed therebetween, and a negative electrode tab joined to the negative electrode, extending in a winding axis direction of the winding body. In the nonaqueous electrolyte battery of the present invention, the positive electrode includes a positive electrode current collector having a strip-like shape, a first positive electrode mixture layer formed on one surface of the positive electrode current collector, and a second positive electrode mixture layer formed on the other surface of the positive electrode current collector, a direction parallel to a main surface of the winding body and perpendicular to the winding axis direction is assumed to be a width direction, a winding trailing end portion of the first positive electrode mixture layer is positioned on an inner side of the winding body with respect to the negative electrode tab in the width direction, and a winding trailing end portion of the second positive electrode mixture layer is positioned on an outer side of the winding body with respect to the negative electrode tab in the width direction.

In the above-discussed structure, the winding trailing end portion of the positive electrode mixture layer (first positive electrode mixture layer) formed on one surface of the positive electrode current collector and the winding trailing end portion of the positive electrode mixture layer (second positive electrode mixture layer) formed on the other surface of the positive electrode current collector are formed away from each other in the width direction of the winding body. The level differences at the end portions of the positive electrode mixture layers can be dispersed in the width direction of the winding body. Therefore, it is possible to alleviate the non-uniformity of pressure received from a battery case when the winding body is expanded during charge/discharge. Consequently, the force imposed on the negative electrode mixture layers, in particular, is uniform. Therefore, the expansion of the winding body 30 is uniform and the undulation in the winding body 30 is suppressed. Since the undulation in the winding body 30 is suppressed, the torsion of the negative electrode tab 36 can be also suppressed.

More specifically, the winding trailing end portion of the first positive electrode mixture layer is positioned on the inner side of the winding body with respect to the negative electrode tab in the width direction of the winding body. The winding trailing end portion of the second positive electrode mixture layer is positioned on the outer side of the winding body with respect to the negative electrode tab in the width direction of the winding body. In other words, the winding trailing end portions of the positive electrode mixture layers are positioned on both sides of the negative electrode tab. It is thereby possible to uniformize the pressure exerted on the negative electrode tab.

Thus, according to the present invention, the winding body can be uniformly expanded, and this prevents the undulation therein.

### BRIEF DESCRIPTION OF DRAWINGS

FIG. 1 is a perspective view schematically showing a structure of a nonaqueous electrolyte battery in accordance with a first embodiment of the present invention;

FIG. 2 is a cross section taken along the line A-A of FIG. 1;

FIG. 3 is a cross section taken along the line B-B of FIG. 1;

FIG. 4A is an elevational view of a positive electrode tab, extractingly showing the vicinity of a winding trailing end portion of a positive electrode;

FIG. 4B is an elevational view of a negative electrode tab, extractingly showing the vicinity of a winding leading end portion of a negative electrode;

FIG. 5 is a cross section schematically showing a structure of a nonaqueous electrolyte battery in accordance with a comparative embodiment;

FIG. 6A is a view for explanation of undulation in a winding body and torsion of the negative electrode tab in the nonaqueous electrolyte battery in accordance with the comparative embodiment;

FIG. 6B is a view for explanation of undulation in a winding body and torsion of the negative electrode tab in the nonaqueous electrolyte battery in accordance with the comparative embodiment;

FIG. 7 is a cross section schematically showing a structure of a nonaqueous electrolyte battery in accordance with a second embodiment of the present invention;

FIG. 8 is a cross section schematically showing a structure of a nonaqueous electrolyte battery in accordance with a third embodiment of the present invention;

FIG. 9 is a cross section schematically showing a structure of a nonaqueous electrolyte battery in accordance with a variation of the present invention;

FIG. 10 is a cross section schematically showing a structure of a nonaqueous electrolyte battery in accordance with another variation of the present invention;

FIG. 11 is a cross section schematically showing a structure of a nonaqueous electrolyte battery in accordance with still another variation of the present invention; and

FIG. 12 is a view showing thickness measurement points in an expansion measurement.

### EMBODIMENTS FOR CARRYING OUT THE INVENTION

Hereinafter, with reference to figures, the embodiments of the present invention will be discussed in detail. In figures, identical or corresponding constituent elements are represented by the same reference signs and redundant description will be omitted. The constituent members in figures are not faithfully shown at actual size, with actual size ratio, or the like.

### The First Embodiment

<Overall Structure>

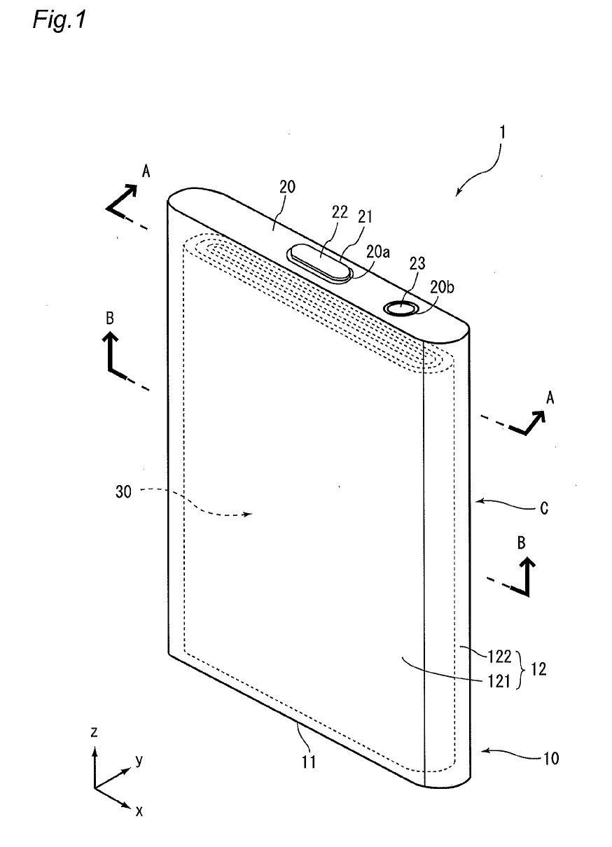

FIG. 1 is a perspective view schematically showing a structure of a nonaqueous electrolyte battery 1 in accordance with the first embodiment of the present invention. The nonaqueous electrolyte battery 1 comprises a bottomed cylindrical exterior can 10, a cover plate 20 for covering an opening of the exterior can 10, and a winding body 30 contained in the exterior can 10. By attaching the cover plate 20 to the exterior can 10, a battery case C having a space therein is achieved. Further, inside the battery case C, a nonaqueous electrolyte solution is encapsulated as well as the winding body 30.

The exterior can 10 is formed of, e.g., an aluminum alloy. The exterior can 10 has a bottom surface 11 and a sidewall 12. The sidewall 12 has a pair of planar portions 121 opposed to each other and semi-cylindrical portions 122 which connect the planar portions 121 to each other.

Herein, a direction of connecting the bottom surface 11 of the exterior can 10 and the cover plate 20 is referred to as a z direction. A direction perpendicular to the z direction and parallel to the planar portions 121 of the exterior can 10 is referred to as an x direction. A direction perpendicular to both the z direction and the x direction is referred to as a y direction. The size of the exterior can 10 in the y direction is smaller than that in the x direction. In other words, the exterior can 10 has a flattened shape.

The exterior can 10 also has a function of a positive electrode of the nonaqueous electrolyte battery 1 as discussed later.

The cover plate 20 is formed of, e.g., an aluminum alloy, like the exterior can 10. The cover plate 20 is fitted in the opening of the exterior can 10 and joined thereto by welding.

A center portion of the cover plate 20 in the x direction is provided with a through hole 20a. In the through hole 20a, an insulation packing 21 made of polypropylene and a negative terminal 22 made of stainless steel are inserted. Specifically, the substantially columnar negative terminal 22 is inserted in the substantially cylindrical insulation packing 21 and the insulation packing 21 is inserted in the through hole 20a.

The cover plate 20 is also provided with an inlet 20b for the nonaqueous electrolyte solution side by side with the through hole 20a. The inlet 20b is sealed with a sealing plug 23. A peripheral portion of the inlet 20b and an outer peripheral portion of the sealing plug 23 are joined to each other by welding.

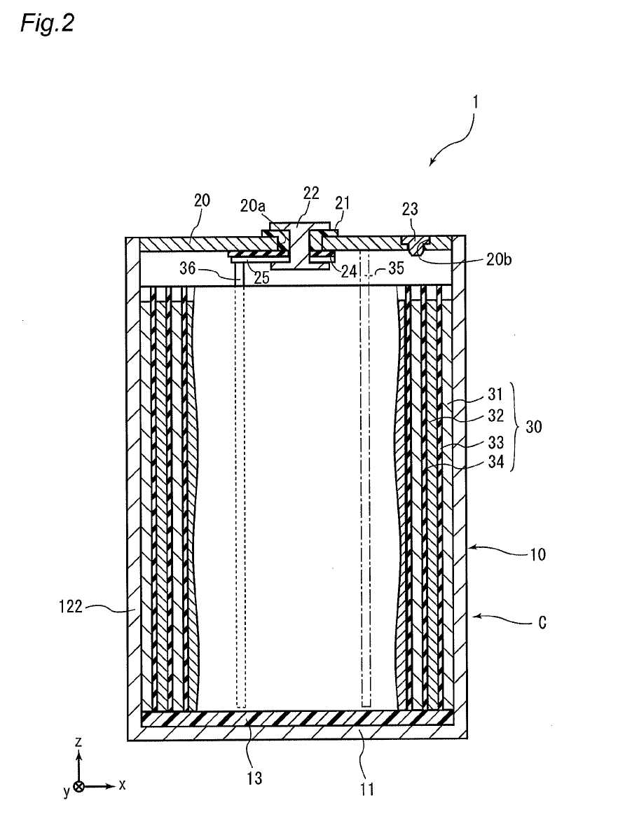

FIG. 2 is a cross section taken along the line A-A of FIG. 1 (xz-plane cross section). The winding body 30 has a positive electrode 31 having a strip-like shape, a negative electrode 32 having a strip-like shape, and two separators 33 and 34. The winding body 30 has a multilayer structure in which the negative electrode 32, the separator 33, the positive electrode 31, and the separator 34 are layered in this order and is wound around the z direction with the negative electrode 32 positioned on the inner side. In FIG. 2, the inner side of the winding body 30 is not shown. The number of turns of the winding body 30 may be arbitrarily chosen.

The size of the winding body 30 in the y direction is smaller than that in the x direction. In other words, the winding body 30 has a flattened shape. Herein, if the winding body 30 is regarded as a similar rectangular parallelepiped, a pair of the largest surfaces (surfaces perpendicular to the y direction) are sometimes referred to as main surfaces of the winding body 30. Further, the x direction is sometimes referred to as a width direction of the winding body 30 and the y direction is sometimes referred to as a thickness direction of the winding body 30. The z direction is sometimes referred to as a winding axis direction of the winding body 30.

A positive electrode tab 35 is joined to the vicinity of a winding trailing end portion of the positive electrode 31. On the other hand, a negative electrode tab 36 is joined to the vicinity of a winding leading end portion of the negative electrode 32. Though the positive electrode tab 35 is not actually present on the plane of FIG. 2, for convenience of illustration, the positive electrode tab 35 is indicated by the one-dot chain line in FIG. 2.

Respective structures of the winding body 30, the positive electrode tab 35, and the negative electrode tab 36 will be described later in detail.

The positive electrode tab 35 is drawn to the outside of the winding body 30 and connected to the cover plate 20. The positive electrode 31 and the cover plate 20 are thereby brought into conduction with each other. Since the cover plate 20 and the exterior can 10 are joined to each other, the positive electrode 31 and the exterior can 10 are also brought into conduction with each other. For this reason, the exterior can 10 also has a function as the positive electrode 31 as discussed earlier.

The negative electrode tab 36 is drawn to the outside of the winding body 30 and connected to the negative terminal 22 with a lead plate 25 interposed therebetween. The negative electrode 32 and the negative terminal 22 are thereby brought into conduction with each other. An insulator 24 is formed between the lead plate 25 and the cover plate 20. The lead plate 25 and the cover plate 20 are thereby insulated from each other.

An insulator 13 made of a polyethylene sheet is formed between the winding body 30 and the bottom surface 11 of the exterior can 10. Therefore, with the exterior can 10 interposed therebetween, the positive electrode 31 and the negative electrode 32 are not short-circuited.

<Structure of Winding Body 30>

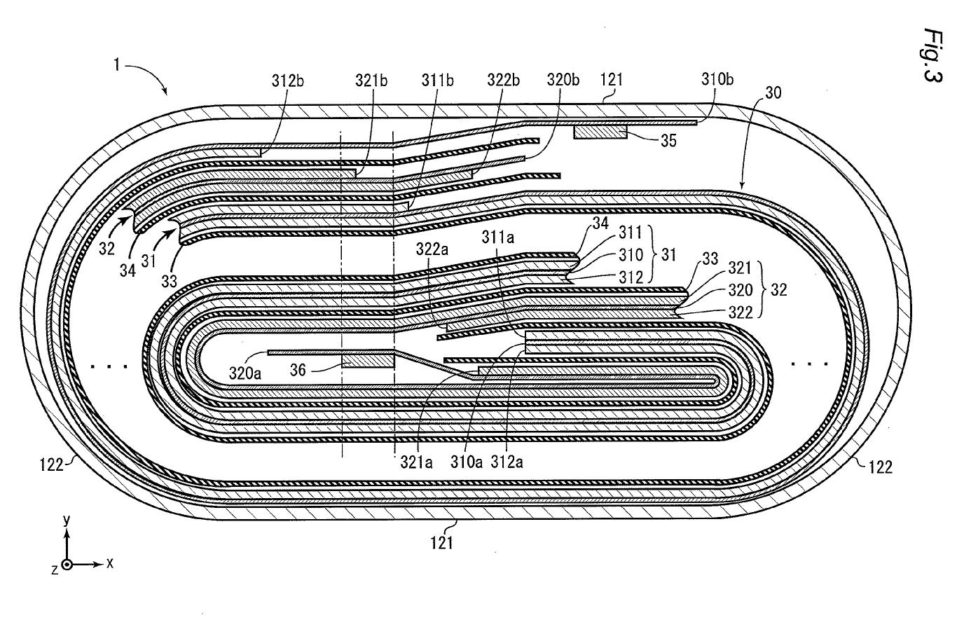

Hereinafter, with reference to FIG. 3, the structure of the winding body 30 will be described in detail. FIG. 3 is a cross section taken along the line B-B of FIG. 1 (xy-plane cross section). FIG. 3 only shows an area of about one round from the innermost side of the winding body 30 and an area of about one round from the outermost side of the winding body 30 and omits an intermediate area. Though the negative electrode 32, the separator 33, the positive electrode 31, and the separator 34 are very closely arranged with almost no clearance in actual cases, FIG. 3 shows these constituent elements, being separated a little from one another, for easy visualization.

The positive electrode 31 includes a positive electrode current collector 310 having a strip-like shape and positive electrode mixture layers 311 and 312 formed on both sides of the positive electrode current collector 310. The positive electrode mixture layer 311 is formed on a surface (outer surface) of the positive electrode current collector 310, which is farther from the winding center of the winding body 30, out of the front and back surfaces thereof. The positive electrode mixture layer 312 is formed on a surface (inner surface) of the positive electrode current collector 310, which is nearer to the winding center of the winding body 30, out of the front and back surfaces thereof.

As the positive electrode current collector 310, for example, a foil made of aluminum, titanium, or the like, a plain weave wire mesh, expanded metal, a lath mesh, perforated metal, or the like may be used. The thickness of the positive electrode current collector 310 is, e.g., 5 to 30 μm.

The positive electrode mixture layers 311 and 312 are formed by mixing a positive electrode active material, an electroconductive aid, and a binder. As the positive electrode active material, lithium manganese oxide, lithium nickel composite oxide, lithium cobalt composite oxide, lithium/nickel/cobalt composite oxide, vanadium oxide, molybdenum oxide, or the like may be used. As the electroconductive aid, graphite, carbon black, acetylene black, or the like may be used. As the binder, polyimide, polyamide imide, polytetrafluoroethylene (PTFE), polyvinylidene fluoride (PVDF), or/and the like may be used solely or by mixture.

The positive electrode mixture layers 311 and 312 are controlled to have a predetermined density by a calendering process. The density of the positive electrode mixture layers 311 and 312 is 2.0 to 3.5 g/cm³, and more preferably 2.3 to 3.3 g/cm³. The thickness of each of the positive electrode mixture layers 311 and 312 is, e.g., 20 to 200 μm.

In the positive electrode 31, part of the positive electrode current collector 310 is exposed on the winding trailing end portion side and the respective positions of the end portions of the mixture layers on the front and back surfaces thereof are different in the width direction (x direction) of the winding body 30. Specifically, as shown in FIG. 3, a winding trailing end portion 310b of the positive electrode current collector 310, a winding trailing end portion 311b of the positive electrode mixture layer 311, and a winding trailing end portion 312b of the positive electrode mixture layer 312 are at different positions in the width direction (x direction) of the winding body 30.

On the other hand, a winding leading end portion 310a of the positive electrode current collector 310, a winding leading end portion 311a of the positive electrode mixture layer 311, and a winding leading end portion 312a of the positive electrode mixture layer 312 are at substantially the same position in the width direction (x direction) of the winding body 30. The structure on the winding leading end portion side of the positive electrode 31, however, may be arbitrarily chosen. The winding leading end portions 310a, 311a, and 312a may be at different positions in the width direction (x direction) of the winding body 30. In the case where these portions are at the same position, however, it is possible to simplify the manufacturing process since it is not necessary to expose the positive electrode current collector 310.

The negative electrode 32 includes a negative electrode current collector 320 having a strip-like shape and negative electrode mixture layers 321 and 322 formed on both sides of the negative electrode current collector 320. The negative electrode mixture layer 321 is formed on a surface (outer surface) of the negative electrode current collector 320, which is farther from the winding center of the winding body 30, out of the front and back surfaces thereof. The negative electrode mixture layer 322 is formed on a surface (inner surface) of the negative electrode current collector 320, which is nearer to the winding center of the winding body 30, out of the front and back surfaces thereof.

As the negative electrode current collector 320, for example, a foil made of copper, nickel, stainless, or the like, a plain weave wire mesh, expanded metal, a lath mesh, perforated metal, or the like may be used. The thickness of the negative electrode current collector 320 is, e.g., 5 to 150 μm.

The negative electrode mixture layers 321 and 322 are formed by mixing a negative electrode active material and a binder. As the negative electrode active material, natural graphite, mesophase carbon, amorphous carbon, or the like may be used. As the binder, cellulose such as carboxymethyl cellulose (CMC), Hydroxy Methyl cellulose (HPC), or the like, a rubber binder such as styrene-butadiene rubber (SBR), acrylic rubber, or the like, PTFE, PVDF, or/and the like may be used solely or by mixture.

As the negative electrode active material, instead of the above-discussed carbon-based negative electrode materials, an alloy-based negative electrode material containing a metallic material (Li, Si, Al, Ge, Pb, As, Sb, or the like) or an oxide-based negative electrode material containing an oxide (SiO, TiO₂, Nb₂O₅, MoO₂, or the like) may be used. Further, these may be used by mixture.

The negative electrode mixture layers 321 and 322 are controlled to have a predetermined density by a calendering process. The density of the negative electrode mixture layers 321 and 322 has to be optimally adjusted depending on the material to be used. In a case of using a graphite material, for example, the density is 1.0 to 1.8 g/cm³, and more preferably 1.2 to 1.6 g/cm³. The thickness of each of the negative electrode mixture layers 321 and 322 is, e.g., 20 to 200 μm.

In the negative electrode 32, part of the negative electrode current collector 320 is exposed on the winding leading end portion side and the respective positions of the end portions of the mixture layers on the front and back surfaces thereof are different in the width direction (x direction) of the winding body 30. Specifically, as shown in FIG. 3, a winding leading end portion 320a of the negative electrode current collector 320, a winding leading end portion 321a of the negative electrode mixture layer 321, and a winding leading end portion 322a of the negative electrode mixture layer 322 are at different positions in the width direction (x direction) of the winding body 30.

Further, a winding trailing end portion 320b of the negative electrode current collector 320, a winding trailing end portion 321b of the negative electrode mixture layer 321, and a winding trailing end portion 322b of the negative electrode mixture layer 322 are at different positions in the width direction (x direction) of the winding body 30.

On the outermost side of the winding body 30, the positive electrode tab 35 is joined to the exposed portion of the positive electrode current collector 310. In the present embodiment, the positive electrode tab 35 is joined to the surface of the positive electrode current collector 310 on the side where the positive electrode mixture layer 312 is formed. The positive electrode tab 35, however, may be joined to the surface of the positive electrode current collector 310 on the side where the positive electrode mixture layer 311 is formed.

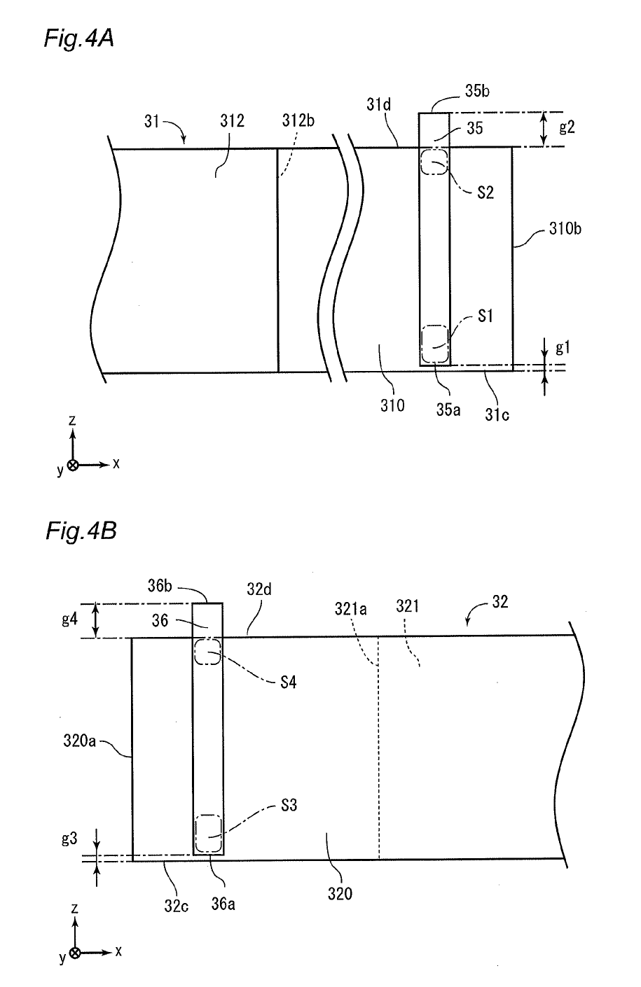

FIG. 4A is an elevational view of the positive electrode tab 35, extractingly showing the vicinity of the winding trailing end portion of the positive electrode 31. As shown in FIG. 4A, the positive electrode tab 35 extends in the winding axis direction (z direction) of the winding body 30. As the positive electrode tab 35, aluminum, titanium, or the like may be used. The thickness of the positive electrode tab 35 is, e.g., 2 to 10 μm.

One end portion 35a of the positive electrode tab 35 is positioned in the vicinity of one end portion 31c (on the side of the bottom surface 11) of the positive electrode 31 in the winding axis direction (z direction). It is preferable that a gap g1 between the end portion 35a of the positive electrode tab 35 and the end portion 31c of the positive electrode 31 is 3 mm or less. More preferably, the gap g1 is 1 mm or less, and the end portion 35a must not protrude from the positive electrode current collector 310.

The other end portion 35b of the positive electrode tab 35 protrudes from the other end portion 31d (on the side of the cover plate 20) of the positive electrode 31 in the winding axis direction (z direction). It is preferable that a gap g2 between the end portion 35b of the positive electrode tab 35 and the end portion 31d of the positive electrode 31 is about 10 mm. More preferably, the gap g2 is 3 to 10 mm.

It is preferable that the positive electrode tab 35 is joined to the positive electrode 31 only at the vicinity of both the end portions of the positive electrode 31 in the winding axis direction (z direction) and a center portion thereof is not joined. More specifically, the positive electrode tab 35 and the positive electrode current collector 310 of the positive electrode 31 are joined to each other only at regions S1 and S2 surrounded by the one-dot chain line in FIG. 4A.

Further, it is preferable that the area of the region S1 in the end portion on the side of the bottom surface 11 is 18 to 27 mm². More preferably, the area is 20 to 25 mm². It is preferable that the area of the region S2 in the end portion on the side of the cover plate 20 is 9 to 18 mm². More preferably, the area is 12 to 15 mm².

On the innermost side of the winding body 30, the negative electrode tab 36 is joined to the exposed portion of the negative electrode current collector 320. In the present embodiment, the negative electrode tab 36 is joined to the surface of the negative electrode current collector 320 on the side where the negative electrode mixture layer 322 is formed. The negative electrode tab 36, however, may be joined to the surface of the negative electrode current collector 320 on the side where the negative electrode mixture layer 321 is formed.

FIG. 4B is an elevational view of the negative electrode tab 36, extractingly showing the vicinity of the winding leading end portion of the negative electrode 32. As shown in FIG. 4B, the negative electrode tab 36 extends in the winding axis direction (z direction) of the winding body 30. As the negative electrode tab 36, copper, nickel, stainless, or the like may be used. The thickness of the negative electrode tab 36 is, e.g., 2 to 10 μm.

One end portion 36a of the negative electrode tab 36 is positioned in the vicinity of one end portion 32c (on the side of the bottom surface 11) of the negative electrode 32 in the winding axis direction (z direction). It is preferable that a gap g3 between the end portion 36a of the negative electrode tab 36 and the end portion 32c of the negative electrode 32 is 3 mm or less. More preferably, the gap g3 is 1 mm or less, and the end portion 36a must not protrude from the negative electrode current collector 320.

The other end portion 36b of the negative electrode tab 36 protrudes from the other end portion 32d (on the side of the cover plate 20) of the negative electrode 32 in the winding axis direction (z direction). It is preferable that a gap g4 between the end portion 36b of the negative electrode tab 36 and the end portion 32d of the negative electrode 32 is about 10 mm. More preferably, the gap g4 is 3 to 10 mm.

It is preferable that the negative electrode tab 36 is joined to the negative electrode 32 only at the vicinity of both the end portions of the negative electrode 32 in the winding axis direction (z direction) and a center portion thereof is not joined. More specifically, the negative electrode tab 36 and the negative electrode current collector 320 of the negative electrode 32 are joined to each other only at regions S3 and S4 surrounded by the one-dot chain line in FIG. 4B.

Further, it is preferable that the area of the region S3 in the end portion on the side of the bottom surface 11 is 18 to 27 mm². More preferably, the area is 20 to 25 mm². It is preferable that the area of the region S4 in the end portion on the side of the cover plate 20 is 9 to 18 mm². More preferably, the area is 12 to 15 mm².

Referring back to FIG. 3, description of the winding body 30 will continue. As the separators 33 and 34, a porous film or a nonwoven fabric made of polypropylene (PP), polyethylene (PE), polyethylene terephthalate (PET), polybutylene terephthalate (PBT), polyphenyl sulfide (PPS), or the like may be used. The thickness of each of the separators 33 and 34 is, e.g., 5 to 30 μm. More preferably, the thickness is 10 to 20 μm.

The nonaqueous electrolyte solution encapsulated in the battery case C together with the winding body 30 is a liquid solution in which lithium salt is dissolved in an organic solvent. As the organic solvent, vinylene carbonate (VC), propylene carbonate (PC), ethylene carbonate (EC), butylene carbonate (BC), dimethyl carbonate (DMC), diethyl carbonate (DEC), methyl ethyl carbonate (MEC), γ-butyrolactone, or/and the like may be used solely or by mixture of two or more kinds. As the lithium salt, LiPF₆, LiBF₄, LiN(CF₃SO₂)₂, or the like may be used.

In the winding body 30, the negative electrode mixture layer 321 is so arranged as to be opposed to the positive electrode mixture layer 312 with the separator 33 interposed therebetween. The negative electrode mixture layer 322 is so arranged as to be opposed to the positive electrode mixture layer 311 with the separator 34 interposed therebetween. In the charge/discharge of the nonaqueous electrolyte battery 1, the guest ions (e.g., lithium ions) are given and received in a portion where the positive electrode mixture layer 311 and the negative electrode mixture layer 322 are opposed to each other and a portion where the positive electrode mixture layer 312 and the negative electrode mixture layer 321 are opposed to each other.

In the pair of the positive electrode mixture layer 311 and the negative electrode mixture layer 322, the area of the negative electrode mixture layer 322 which is a side of receiving the guest ions has to be larger than the area of the positive electrode mixture layer 311. Therefore, in the present embodiment, the winding leading end portion 322a of the negative electrode mixture layer 322 is positioned on the side of the winding leading end portion 320a of the negative electrode current collector 320 with respect to the winding leading end portion 311a of the positive electrode mixture layer 311. Further, the winding trailing end portion 322b of the negative electrode mixture layer 322 is positioned on the side of the winding trailing end portion 320b of the negative electrode current collector 320 with respect to the winding trailing end portion 311b of the positive electrode mixture layer 311.

Similarly, the area of the negative electrode mixture layer 321 has to be larger than the area of the positive electrode mixture layer 312. Therefore, in the present embodiment, the winding leading end portion 321a of the negative electrode mixture layer 321 is positioned on the side of the winding leading end portion 320a of the negative electrode current collector 320 with respect to the winding leading end portion 312a of the positive electrode mixture layer 312. Further, the winding trailing end portion 321b of the negative electrode mixture layer 321 is positioned on the side of the winding trailing end portion 320b of the negative electrode current collector 320 with respect to the winding trailing end portion 312b of the positive electrode mixture layer 312.

In the nonaqueous electrolyte battery 1, the winding trailing end portion 311b of the positive electrode mixture layer 311 is positioned on the inner side of the winding body 30 with respect to the negative electrode tab 36 in the width direction (x direction) of the winding body 30. Further, the winding trailing end portion 312b of the positive electrode mixture layer 312 is positioned on the outer side of the winding body 30 with respect to the negative electrode tab 36 in the width direction (x direction) of the winding body 30. In other words, the negative electrode tab 36 is positioned between the winding trailing end portions 311b and 312b.

<Method of Manufacturing Nonaqueous Electrolyte Battery 1>

A manufacturing method discussed below is illustrative and not restrictive of the present invention.

The positive electrode active material, the electroconductive aid, and the binder are sufficiently mixed in pure water or the organic solvent, to thereby produce a dispersing element (slurry). The slurry is applied onto both the surfaces of the positive electrode current collector 310 by using a die coater, a slit coater, a dip coater, or the like. After this coating, the slurry is dried and subsequently adjusted to have a predetermined thickness and a predetermined density by performing the calendering process. Through this process, the positive electrode 31 in which the positive electrode mixture layers 311 and 312 are formed on the positive electrode current collector 310 is achieved. In the positive electrode 31, the positive electrode tab 35 is joined to the exposed portion of the positive electrode current collector 310 by welding or using a conductive adhesive or the like.

The negative electrode active material and the binder are sufficiently mixed in pure water or the organic solvent, to thereby produce a dispersing element (slurry). The slurry is applied onto both the surfaces of the negative electrode current collector 320 by using a die coater, a slit coater, a dip coater, or the like. After this coating, the slurry is dried and subsequently adjusted to have a predetermined thickness and a predetermined density by performing the calendering process. Through this process, the negative electrode 32 in which the negative electrode mixture layers 321 and 322 are formed on the negative electrode current collector 320 is achieved. In the negative electrode 32, the negative electrode tab 36 is joined to the exposed portion of the negative electrode current collector 320 by welding or using a conductive adhesive or the like.

The negative electrode 32, the separator 33, the positive electrode 31, and the separator 34 are layered in this order. This layered body is wound around a circular or elliptical winding core by a winding machine. After winding, the winding core is drawn out and pressure is imposed in one direction, to make the winding body 30 into a flattened shape. Alternatively, the layered body may be wound around a winding core having a flattened shape by the winding machine, to thereby produce the winding body 30 having a flattened shape.

The end portion 35b of the positive electrode tab 35 is welded to the cover plate 20 and the end portion 36b of the negative electrode tab 36 is welded to the lead plate 25. The winding body 30 is put into the exterior can 10, and the exterior can 10 and the cover plate 20 are welded to each other. The nonaqueous electrolyte solution is injected therein from the inlet 20b of the cover plate 20. After injection, the inlet 20b is sealed with the sealing plug 23 and the peripheral portion of the inlet 20b and the outer peripheral portion of the sealing plug 23 are welded to each other.

<Effects of Nonaqueous Electrolyte Battery 1>

In the structure of the nonaqueous electrolyte battery 1, the winding trailing end portion 311b of the positive electrode mixture layer 311 formed on one surface of the positive electrode current collector 310 and the winding trailing end portion 312b of the positive electrode mixture layer 312 formed on the other surface of the positive electrode current collector 310 are away from each other in the width direction (x direction) of the winding body 30. The level difference at the winding trailing end portion 311b and that at the winding trailing end portion 312b are thereby dispersed in the width direction (x direction) of the winding body 30. Therefore, it is possible to alleviate the non-uniformity of the pressure received from the battery case C when the winding body 30 is expanded during the charge/discharge. Consequently, the force imposed on the negative electrode mixture layers 321 and 322, in particular, is uniform. Therefore, the expansion of the winding body 30 is uniform and the undulation in the winding body 30 is suppressed. Since the undulation in the winding body 30 is suppressed, the torsion of the negative electrode tab 36 can be also suppressed.

More specifically, the winding trailing end portion 311b of the positive electrode mixture layer 311 is positioned on the inner side of the winding body 30 with respect to the negative electrode tab 36 in the width direction (x direction) of the winding body 30. The winding trailing end portion 312b of the positive electrode mixture layer 312 is positioned on the outer side of the winding body 30 with respect to the negative electrode tab 36 in the width direction (x direction) of the winding body 30. In other words, the winding trailing end portions 311b and 312b are arranged on both sides of the negative electrode tab 36. It is thereby possible to uniformize the pressure exerted on the negative electrode tab 36.

The winding body 30 is expanded also in the winding axis direction (z direction) and the width direction (x direction) of the winding body. For this reason, as shown in FIG. 4A, it is preferable that the positive electrode tab 35 is joined to the positive electrode 31 only at the vicinity of both the end portions of the positive electrode 31 in the winding axis direction (z direction) and the center portion thereof is not joined. Since the entire surface is not fixed, it is possible to alleviate the distortion. The same applies to the negative electrode tab 36, and specifically, it is preferable that the negative electrode tab 36 is joined to the negative electrode 32 only at the vicinity of both the end portions of the negative electrode 32 in the winding axis direction (z direction) and the center portion thereof is not joined.

The present invention can be preferably utilized particularly in the case where a material containing a metal or an oxide is used as the negative electrode active material. This is because the negative electrode 32 including such a negative electrode active material has especially large expansion coefficient during the charge/discharge. As one example, while the expansion coefficient of a carbon-based negative electrode material is about 120%, the expansion coefficient of the negative electrode material containing a metallic material sometimes reaches 200%.

### Comparative Embodiment

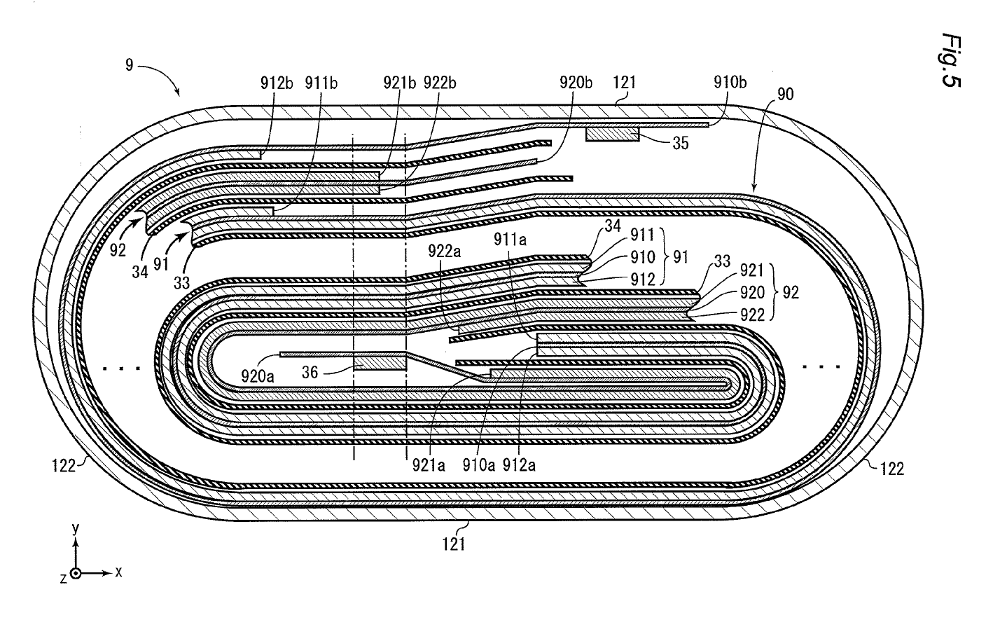

Herein, a virtual comparative embodiment will be discussed in order to explain the effects of the nonaqueous electrolyte battery 1 in accordance with the present embodiment of the present invention. FIG. 5 is a cross section schematically showing a structure of a nonaqueous electrolyte battery 9 in accordance with the comparative embodiment. The nonaqueous electrolyte battery 9 comprises a winding body 90 instead of the winding body 30 included in the nonaqueous electrolyte battery 1.

The winding body 90 includes a positive electrode 91 consisting of a positive electrode current collector 910 and positive electrode mixture layers 911 and 912, a negative electrode 92 consisting of a negative electrode current collector 920 and negative electrode mixture layers 921 and 922, and the separators 33 and 34. In FIG. 5, reference signs 910a, 911a, 912a, 920a, 921a, and 922a represent winding leading end portions of the positive electrode current collector 910, the positive electrode mixture layer 911, the positive electrode mixture layer 912, the negative electrode current collector 920, the negative electrode mixture layer 921, and the negative electrode mixture layer 922, respectively. Reference signs 910b, 911b, 912b, 920b, 921b, and 922b represent winding trailing end portions of the positive electrode current collector 910, the positive electrode mixture layer 911, the positive electrode mixture layer 912, the negative electrode current collector 920, the negative electrode mixture layer 921, and the negative electrode mixture layer 922, respectively.

In the winding body 90, the winding trailing end portion 911b of the positive electrode mixture layer 911 and the winding trailing end portion 912b of the positive electrode mixture layer 912 are at substantially the same position in the width direction (x direction) of the winding body 90. For this reason, in this position, there is a relatively large level difference caused by the total thickness of the positive electrode mixture layers 911 and 912. Further, both the winding trailing end portions 911b and 912b are positioned on the outer side of the winding body 90 with respect to the negative electrode tab 36 in the width direction (x direction) of the winding body 90.

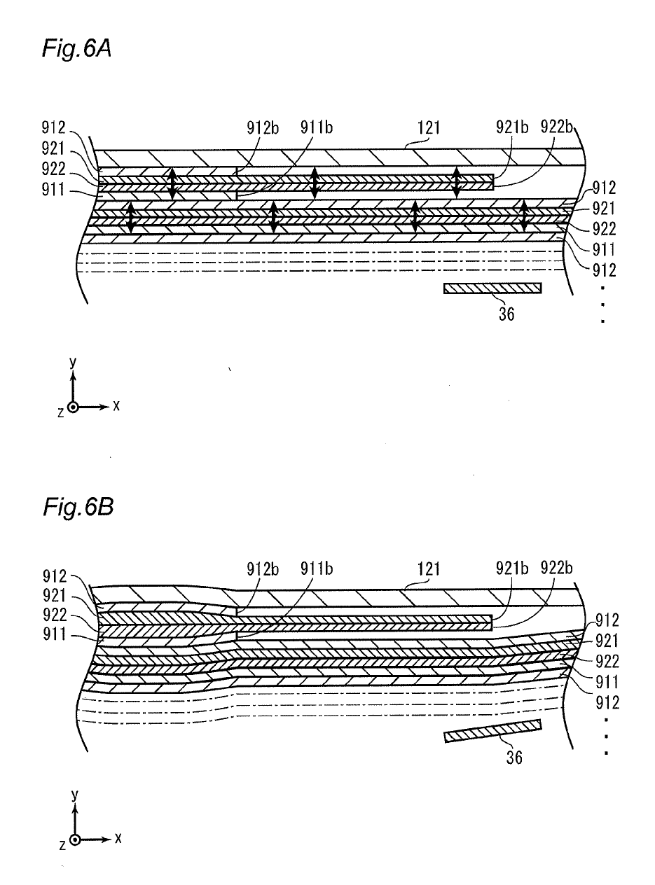

FIGS. 6A and 6B are views for explanation of undulation in the winding body 90 and torsion of the negative electrode tab 36 in the nonaqueous electrolyte battery 9. FIGS. 6A and 6B are cross section schematically showing the vicinity of the winding trailing end portion 911b of the positive electrode mixture layer 911 and the winding trailing end portion 912b of the positive electrode mixture layer 912 and the negative electrode tab 36, which are extracted from the structure of the nonaqueous electrolyte battery 9. In FIGS. 6A and 6B, the positive electrode current collector 910, the negative electrode current collector 920, and the separators 33 and 34 are not shown.

When the nonaqueous electrolyte battery 9 is charged, the negative electrode 92 is expanded, as indicated by the arrows in FIG. 6A. With the expansion of the negative electrode 92, the whole winding body 90 tends to be expanded. The winding body 90, however, is usually contained in the battery case C with almost no clearance. For this reason, the winding body 90 receives pressure from the battery case C (the planar portion 121 of the sidewall 12 of the battery case C in FIG. 6A) in a direction of suppressing the expansion.

In this case, there is a relatively large level difference caused by the winding trailing end portion 911b of the positive electrode mixture layer 911 and the winding trailing end portion 912b of the positive electrode mixture layer 912 in the winding body 90. The pressure imposed from the battery case C is non-uniform depending on the position relative to the level difference. By receiving the non-uniform pressure, the negative electrode mixture layers 921 and 922 are non-uniformly expanded. Consequently, as shown in FIG. 6B, there arises undulation in the winding body 90.

Further, in the nonaqueous electrolyte battery 9, both the winding trailing end portions 911b and 912b are positioned on the outer side of the winding body 90 with respect to the negative electrode tab 36 in the width direction (x direction) of the winding body 90. For this reason, the negative electrode mixture layers 921 and 922 are non-uniformly expanded depending on the position relative to the negative electrode tab 36. In other words, the negative electrode tab 36 receives a non-uniform force through the undulation in the winding body 90 in the width direction (x direction) of the winding body 90. Consequently, there arises torsion in the negative electrode tab 36. In some cases, the torsion of the negative electrode tab 36 cannot be resolved even if the nonaqueous electrolyte battery 9 is discharged to remove the expansion of the winding body 90.

Such undulation in the winding body 90 and torsion of the negative electrode tab 36 deteriorate the battery properties of the nonaqueous electrolyte battery 9. Further, since the winding body 90 is locally expanded against the pressure from the battery case C, the nonaqueous electrolyte battery 9 cannot sometimes meet the thickness specification.

In the structure of the nonaqueous electrolyte battery 1 in accordance with the present embodiment of the present invention, the level difference at the winding trailing end portion 311b and the level difference at the winding trailing end portion 312b are dispersed in the width direction (x direction) of the winding body 30. Therefore, it is possible to alleviate the non-uniformity of the pressure received from the battery case C when the winding body 30 is expanded during the charge/discharge. Further, the winding trailing end portions 311b and 312b are arranged on both sides of the negative electrode tab 36. It is thereby possible to uniformize the pressure exerted on the negative electrode tab 36.

### The Second Embodiment

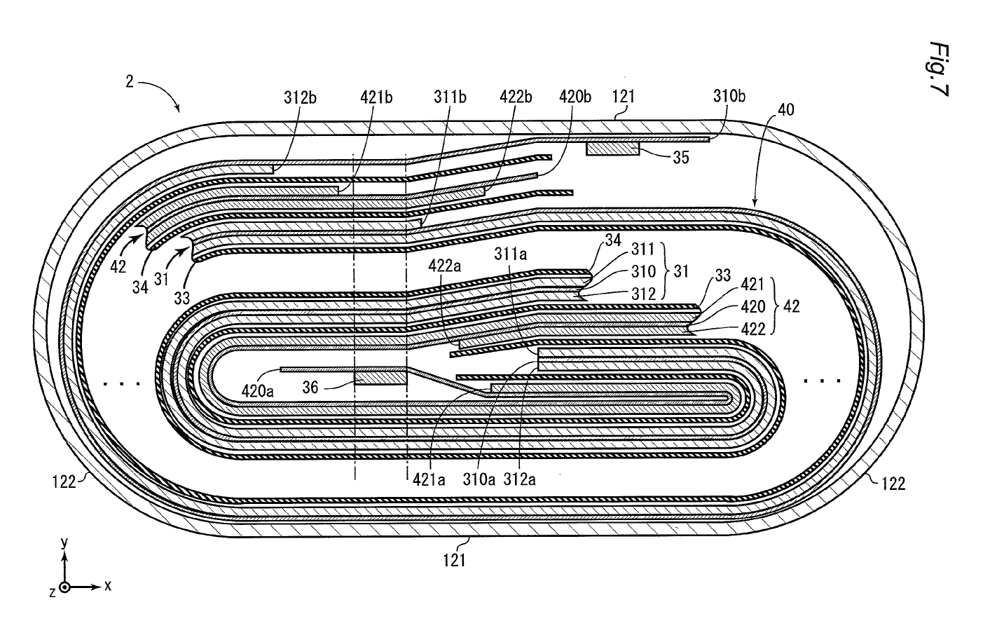

FIG. 7 is a cross section schematically showing a structure of a nonaqueous electrolyte battery 2 in accordance with the second embodiment of the present invention. The nonaqueous electrolyte battery 2 comprises a winding body 40 instead of the winding body 30 included in the nonaqueous electrolyte battery 1.

In the winding body 40, the structure of the negative electrode is different from that in the winding body 30. Specifically, the winding body 40 includes a negative electrode 42 instead of the negative electrode 32. The negative electrode 42 includes a negative electrode current collector 420 and negative electrode mixture layers 421 and 422. In FIG. 7, reference signs 420a, 421a, and 422a represent winding leading end portions of the negative electrode current collector 420, the negative electrode mixture layer 421, and the negative electrode mixture layer 422, respectively. Reference signs 420b, 421b, and 422b represent winding trailing end portions of the negative electrode current collector 420, the negative electrode mixture layer 421, and the negative electrode mixture layer 422, respectively.

In the present embodiment, the winding trailing end portion 421b of the negative electrode mixture layer 421 is positioned between the winding trailing end portion 312b of the positive electrode mixture layer 312 and the negative electrode tab 36 in the width direction (x direction) of the winding body 40. With this arrangement, the winding trailing end portion 421b of the negative electrode mixture layer 421 is not positioned between both the end portions of the negative electrode tab 36 in the width direction (x direction) of the winding body 40. Further, the winding trailing end portion 422b of the negative electrode mixture layer 422 is positioned between the winding trailing end portion 311b of the positive electrode mixture layer 311 and the positive electrode tab 35 in the width direction (x direction) of the winding body 40.

In the structure of the nonaqueous electrolyte battery 2, neither the winding trailing end portion 421b of the negative electrode mixture layer 421 nor the winding trailing end portion 422b of the negative electrode mixture layer 422 is positioned between both the end portions of the negative electrode tab 36 in the width direction (x direction) of the winding body 40. In other words, when the winding trailing end portions 421b and 422b are projected on the xz plane, neither the winding trailing end portion 421b nor the winding trailing end portion 422b overlaps the negative electrode tab 36. When the negative electrode 42 is expanded, it is thereby possible to prevent the torsion of the negative electrode tab 36 with the difference in expansion between the winding trailing end portions 421b and 422b.

Further, in the structure of the nonaqueous electrolyte battery 2, the negative electrode tab 36 is positioned not only between the winding trailing end portion 311b of the positive electrode mixture layer 311 and the winding trailing end portion 312b of the positive electrode mixture layer 312 but also between the winding trailing end portion 421b of the negative electrode mixture layer 421 and the winding trailing end portion 422b of the negative electrode mixture layer 422 in the width direction (x direction) of the winding body 40. This makes the pressure received from the winding body 40 symmetrical with respect to the negative electrode tab 36. It is therefore possible to prevent the torsion of the negative electrode tab 36.

The structure of the nonaqueous electrolyte battery 2 is more preferable than that of the nonaqueous electrolyte battery 1. This is because the winding trailing end portion 321b of the negative electrode mixture layer 321 overlaps the negative electrode tab 36 in the nonaqueous electrolyte battery 1 (FIG. 3) when it is projected on the xz plane. This is further because the negative electrode tab 36 is not positioned between the winding trailing end portions 321b and 322b in the nonaqueous electrolyte battery 1. In other words, one winding trailing end portion (312b) is present on one side of the negative electrode tab 36 and two winding trailing end portions (311b and 322b) are present on the other side thereof in the structure of the nonaqueous electrolyte battery 1 while two winding trailing end portions (312b and 421b) are present on one side of the negative electrode tab 36 and another two winding trailing end portions (311b and 422b) are present on the other side thereof in the structure of the nonaqueous electrolyte battery 2. This makes the force exerted on the negative electrode tab 36 symmetrical in the nonaqueous electrolyte battery 2. Therefore, the torsion of the negative electrode tab 36 is less likely to occur in the structure of the nonaqueous electrolyte battery 2 than in the structure of the nonaqueous electrolyte battery 1.

### The Third Embodiment

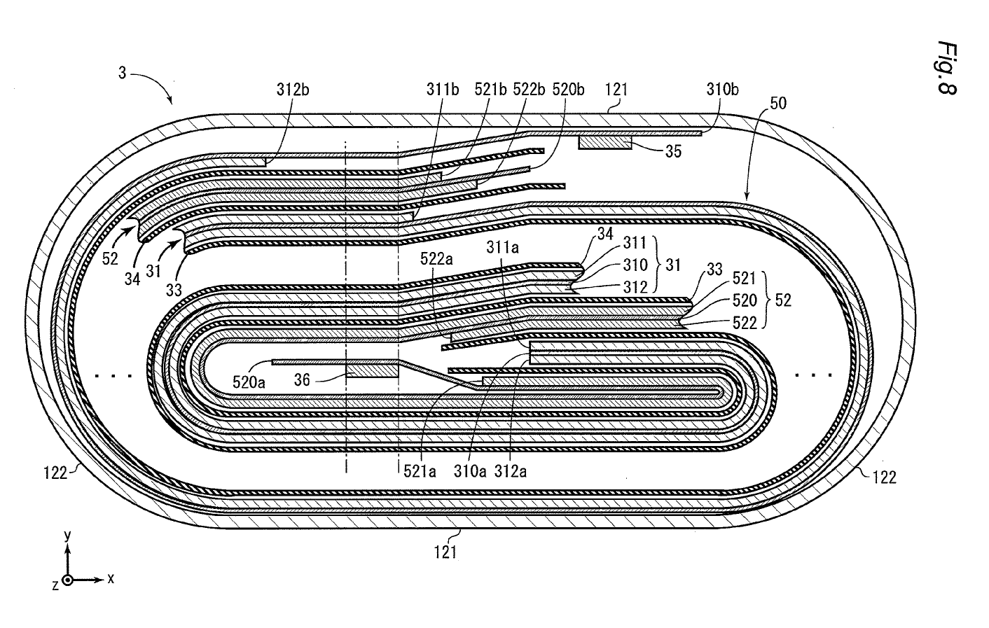

FIG. 8 is a cross section schematically showing a structure of a nonaqueous electrolyte battery 3 in accordance with the third embodiment of the present invention. The nonaqueous electrolyte battery 3 comprises a winding body 50 instead of the winding body 30 included in the nonaqueous electrolyte battery 1.

In the winding body 50, the structure of the negative electrode is different from that in the winding body 30. Specifically, the winding body 50 includes a negative electrode 52 instead of the negative electrode 32. The negative electrode 52 includes a negative electrode current collector 520 and negative electrode mixture layers 521 and 522. In FIG. 8, reference signs 520a, 521a, and 522a represent winding leading end portions of the negative electrode current collector 520, the negative electrode mixture layer 521, and the negative electrode mixture layer 522, respectively. Reference signs 520b, 521b, and 522b represent winding trailing end portions of the negative electrode current collector 520, the negative electrode mixture layer 521, and the negative electrode mixture layer 522, respectively.

In the present embodiment, the winding trailing end portion 521b of the negative electrode mixture layer 521 is positioned between the negative electrode tab 36 and the positive electrode tab 35 in the width direction (x direction) of the winding body 50. Further, the winding trailing end portion 522b of the negative electrode mixture layer 522 is positioned between the winding trailing end portion 311b of the positive electrode mixture layer 311 and the positive electrode tab 35 in the width direction (x direction) of the winding body 50.

In the structure of the nonaqueous electrolyte battery 3, like in the nonaqueous electrolyte battery 2, neither the winding trailing end portion 521b of the positive electrode mixture layer 521 nor the winding trailing end portion 522b of the positive electrode mixture layer 522 is positioned between both the end portions of the negative electrode tab 36 in the width direction (x direction) of the winding body 50. In other words, when the winding trailing end portions 521b and 522b are projected on the xz plane, neither the winding trailing end portion 521b nor the winding trailing end portion 522b overlaps the negative electrode tab 36. When the negative electrode 52 is expanded, it is thereby possible to prevent the torsion of the negative electrode tab 36 with the difference in expansion between the winding trailing end portions 521b and 522b.

Further, in the structure of the nonaqueous electrolyte battery 3, both the winding trailing end portions 521b and 522b are positioned between the positive electrode tab 35 and the negative electrode tab 36. Since the positive electrode tab 35 and the negative electrode tab 36 each have a certain thickness, the thickness (the size in the y direction) of the winding body 50 is the thinnest in the portion between the positive electrode tab 35 and the negative electrode tab 36. By positioning the winding trailing end portions 521b and 522b in this portion, the thickness of the thickest portion of the winding body 50 can be thinned. Therefore, the structure of the nonaqueous electrolyte battery 3 is more preferable than those of the nonaqueous electrolyte batteries 1 and 2.

Further, in the present embodiment, the winding trailing end portion 520b of the negative electrode current collector 520, the winding trailing end portion 521b of the negative electrode mixture layer 521, and the winding trailing end portion 522b of the negative electrode mixture layer 522 are at different positions in the width direction (x direction) of the winding body 50. The structure on the side of the winding trailing end portion of the negative electrode 52, however, may be arbitrarily chosen. A pair of any two of the winding trailing end portions 520b, 521b, and 522b or all the winding trailing end portions 520b, 521b, and 522b may be at the same position in the width direction (x direction) of the winding body 50. In the case where all the winding trailing end portions 520b, 521b, and 522b are at the same position, particularly, it is possible to simplify the manufacturing process since it is not necessary to expose the negative electrode current collector 520.

<Variations of Nonaqueous Electrolyte Batteries 1 to 3>

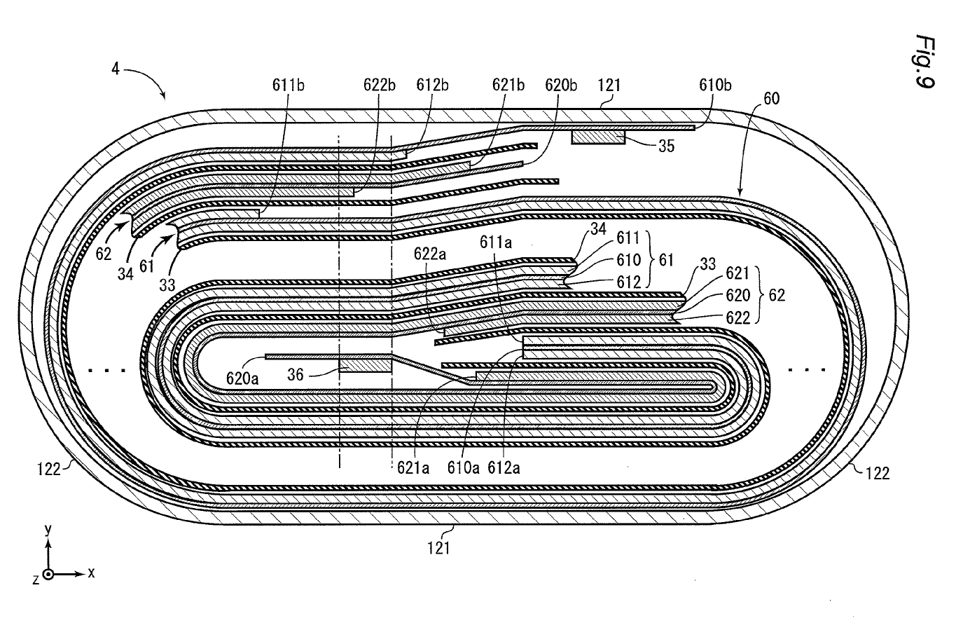

FIGS. 9 to 11 are cross sections schematically showing structures of nonaqueous electrolyte batteries 4 to 6 in accordance with variations of the nonaqueous electrolyte batteries 1 to 3, respectively. The nonaqueous electrolyte batteries 4 to 6 comprise winding bodies 60, 70, and 80, respectively.

The winding bodies 60, 70, and 80 include a positive electrode 61 and the separators 33 and 34 in common. The positive electrode 61 includes a positive electrode current collector 610 and positive electrode mixture layers 611 and 612. In FIGS. 9 to 11, reference signs 610a, 611a, and 612a represent winding leading end portions of the positive electrode current collector 610, the positive electrode mixture layer 611, and the positive electrode mixture layer 612, respectively. Reference signs 610b, 611b, and 612b represent winding trailing end portions of the positive electrode current collector 610, the positive electrode mixture layer 611, and the positive electrode mixture layer 612, respectively.

In the nonaqueous electrolyte batteries 4 to 6, the winding trailing end portion 612b of the positive electrode mixture layer 612 is positioned on the inner side of the winding body 60 (70, 80) with respect to the negative electrode tab 36 in the width direction (x direction) of the winding body 60 (70, 80). Further, the winding trailing end portion 611b of the positive electrode mixture layer 611 is positioned on the outer side of the winding body 60 (70, 80) with respect to the negative electrode tab 36 in the width direction (x direction) of the winding body 60 (70, 80). In other words, the negative electrode tab 36 is positioned between the winding trailing end portions 611b and 612b in the width direction (x direction) of the winding body 60 (70, 80).

Like in the nonaqueous electrolyte batteries 1 to 3, the level difference at the winding trailing end portion 611b and that at the winding trailing end portion 612b are thereby dispersed in the width direction (x direction) of the winding body 60 (70, 80). Therefore, it is possible to alleviate the non-uniformity of the pressure received from the battery case C when the winding body 60 (70, 80) is expanded during the charge/discharge. Further, by arranging the winding trailing end portions 611b and 612b with the negative electrode tab 36 between them, it is possible to uniformize the pressure exerted on the negative electrode tab 36.

In the nonaqueous electrolyte batteries 4 to 6, the winding trailing end portion 612b of the positive electrode mixture layer 612 on the outer side of the winding body 60 (70, 80) is positioned on the inner side of the winding body 60 (70, 80) with respect to the negative electrode tab 36 in the width direction (x direction) of the winding body 60 (70, 80).

As the structure in which the negative electrode tab 36 is positioned between the winding trailing end portions 611b and 612b, there are two possible structures, i.e., a structure (A) in which the winding trailing end portion 612b is positioned on the outer side with respect to the negative electrode tab 36 and the winding trailing end portion 611b is positioned on the inner side with respect to the negative electrode tab 36 and a structure (B) in which the winding trailing end portion 612b is positioned on the inner side with respect to the negative electrode tab 36 and the winding trailing end portion 611b is positioned on the outer side with respect to the negative electrode tab 36. The structure of the nonaqueous electrolyte batteries 1 to 3 corresponds to the structure (A) and the structure of the nonaqueous electrolyte batteries 4 to 6 corresponds to the structure (B).

It can be clearly seen from FIGS. 9 to 11 that in the structure (B), the winding trailing end portion 611b on the inner side of the winding body 60 (70, 80) is positioned on the outer side with respect to the winding trailing end portion 612b positioned outward in the width direction (x direction) of the winding body 60 (70, 80). Therefore, when the positive electrode 61, a negative electrode 62 (72, 82), and the separators 33 and 34 are closely arranged without any clearance and wound, there arises a bent portion in at least the positive electrode mixture layer 612, which is caused by the winding trailing end portion 611b. On the other hand, it can be clearly seen from FIGS. 3, 7, and 8 that in the structure (A), there arises no bent portion. Therefore, the structure (A) is more preferable than the structure (B).

With reference to FIG. 9, the winding body 60 included in the nonaqueous electrolyte battery 4 includes the negative electrode 62. The negative electrode 62 includes a negative electrode current collector 620 and negative electrode mixture layers 621 and 622. In FIG. 9, reference signs 620a, 621a, and 622a represent winding leading end portions of the negative electrode current collector 620, the negative electrode mixture layer 621, and the negative electrode mixture layer 622, respectively. Reference signs 620b, 621b, and 622b represent winding trailing end portions of the negative electrode current collector 620, the negative electrode mixture layer 621, and the negative electrode mixture layer 622, respectively.

Like in the nonaqueous electrolyte battery 1, since the area of the negative electrode mixture layer 622 has to be larger than the area of the positive electrode mixture layer 611 which is opposed thereto, the winding trailing end portion 622b of the negative electrode mixture layer 622 is positioned on the side of the winding trailing end portion 620b of the negative electrode current collector 620 with respect to the winding trailing end portion 611b of the positive electrode mixture layer 611. Since the area of the negative electrode mixture layer 621 has to be larger than the area of the positive electrode mixture layer 612 which is opposed thereto, the winding trailing end portion 621b of the negative electrode mixture layer 621 is positioned on the side of the winding trailing end portion 620b of the negative electrode current collector 620 with respect to the winding trailing end portion 612b of the positive electrode mixture layer 612.

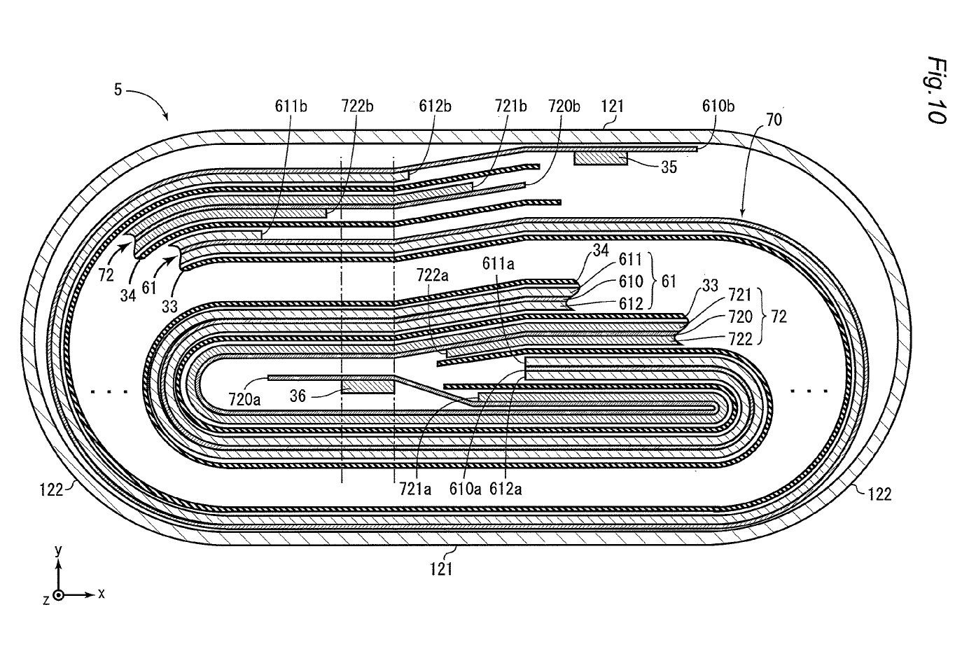

With reference to FIG. 10, the winding body 70 included in the nonaqueous electrolyte battery 5 includes the negative electrode 72. The negative electrode 72 includes a negative electrode current collector 720 and negative electrode mixture layers 721 and 722. In FIG. 10, reference signs 720a, 721a, and 722a represent winding leading end portions of the negative electrode current collector 720, the negative electrode mixture layer 721, and the negative electrode mixture layer 722, respectively. Reference signs 720b, 721b, and 722b represent winding trailing end portions of the negative electrode current collector 720, the negative electrode mixture layer 721, and the negative electrode mixture layer 722, respectively.

The winding trailing end portion 722b of the negative electrode mixture layer 722 is positioned between the winding trailing end portion 611b of the positive electrode mixture layer 611 and the negative electrode tab 36 in the width direction (x direction) of the winding body 70. With this arrangement, the winding trailing end portion 722b of the negative electrode mixture layer 722 is not positioned between both the end portions of the negative electrode tab 36 in the width direction (x direction) of the winding body 70. Further, the winding trailing end portion 721b of the negative electrode mixture layer 721 is positioned between the winding trailing end portion 612b of the positive electrode mixture layer 612 and the positive electrode tab 35 in the width direction (x direction) of the winding body 70.

In the structure of the nonaqueous electrolyte battery 5, when the winding trailing end portions 721b and 722b are projected on the xz plane, neither the winding trailing end portion 721b nor the winding trailing end portion 722b overlaps the negative electrode tab 36. When the negative electrode 72 is expanded, it is thereby possible to prevent the torsion of the negative electrode tab 36 with the difference in expansion between the winding trailing end portions 721b and 722b. Further, the negative electrode tab 36 is positioned between the winding trailing end portions 721b and 722b. This makes the pressure received from the winding body 70 symmetrical with respect to the negative electrode tab 36. Therefore, the structure of the nonaqueous electrolyte battery 5 is more preferable than that of the nonaqueous electrolyte battery 4. This is because the winding trailing end portion 622b of the negative electrode mixture layer 622 overlaps the negative electrode tab 36 in the nonaqueous electrolyte battery 4 (FIG. 9) when it is projected on the xz plane. This is further because the negative electrode tab 36 is not positioned between the winding trailing end portions 621b and 622b in the nonaqueous electrolyte battery 4. In other words, one winding trailing end portion (611b) is present on one side of the negative electrode tab 36 and two winding trailing end portions (612b and 621b) are present on the other side thereof in the structure of the nonaqueous electrolyte battery 4 while two winding trailing end portions (611b and 722b) are present on one side of the negative electrode tab 36 and another two winding trailing end portions (612b and 721b) are present on the other side thereof in the structure of the nonaqueous electrolyte battery 5. This makes the force exerted on the negative electrode tab 36 symmetrical in the nonaqueous electrolyte battery 5. Therefore, the torsion of the negative electrode tab 36 is less likely to occur in the structure of the nonaqueous electrolyte battery 5 than in the structure of the nonaqueous electrolyte battery 4.

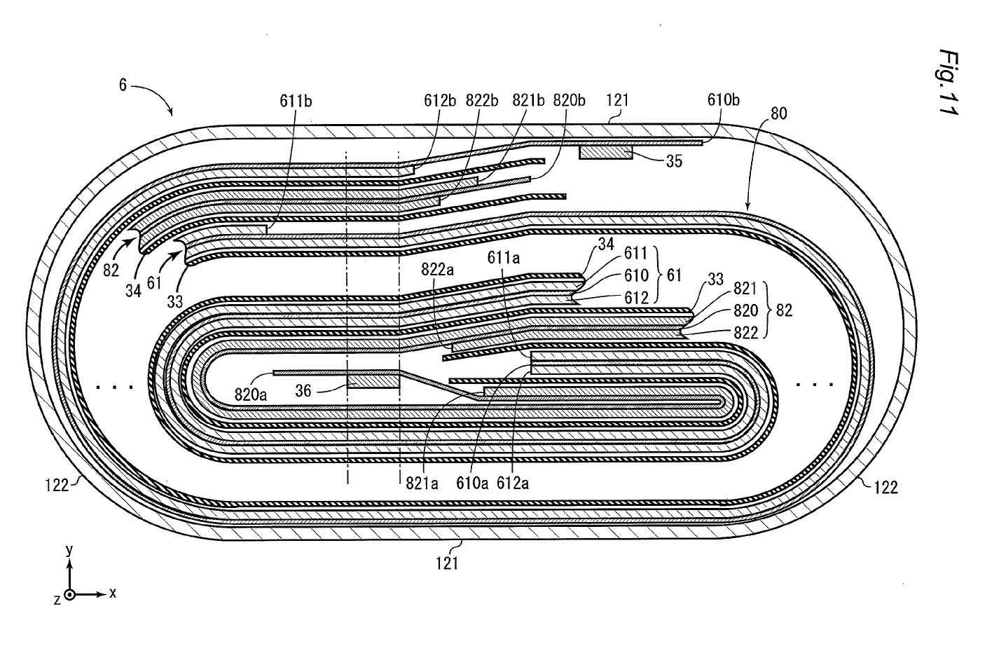

With reference to FIG. 11, the winding body 80 included in the nonaqueous electrolyte battery 6 includes the negative electrode 82. The negative electrode 82 includes a negative electrode current collector 820 and negative electrode mixture layers 821 and 822. In FIG. 11, reference signs 820a, 821a, and 822a represent winding leading end portions of the negative electrode current collector 820, the negative electrode mixture layer 821, and the negative electrode mixture layer 822, respectively. Reference signs 820b, 821b, and 822b represent winding trailing end portions of the negative electrode current collector 820, the negative electrode mixture layer 821, and the negative electrode mixture layer 822, respectively.

The winding trailing end portion 822b of the negative electrode mixture layer 822 is positioned between the negative electrode tab 36 and the positive electrode tab 35 in the width direction (x direction) of the winding body 80. Further, the winding trailing end portion 821b of the negative electrode mixture layer 821 is positioned between the winding trailing end portion 612b of the positive electrode mixture layer 612 and the positive electrode tab 35 in the width direction (x direction) of the winding body 80.

In the structure of the nonaqueous electrolyte battery 6, like in the nonaqueous electrolyte battery 5, when the winding trailing end portions 821b and 822b are projected on the xz plane, neither the winding trailing end portion 821b nor the winding trailing end portion 822b overlaps the negative electrode tab 36. When the negative electrode 82 is expanded, it is thereby possible to prevent the torsion of the negative electrode tab 36 with the difference in expansion between the winding trailing end portions 821b and 822b.

In the structure of the nonaqueous electrolyte battery 6, further, both the winding trailing end portions 821b and 822b are positioned between the positive electrode tab 35 and the negative electrode tab 36. Since the positive electrode tab 35 and the negative electrode tab 36 each have a certain thickness, the thickness (the size in the y direction) of the winding body 80 is the thinnest in the portion between the positive electrode tab 35 and the negative electrode tab 36. By positioning the winding trailing end portions 821b and 822b in this portion, the thickness of the thickest portion of the winding body 80 can be thinned. Therefore, the structure of the nonaqueous electrolyte battery 6 is more preferable than those of the nonaqueous electrolyte batteries 4 and 5.

In summary, among the embodiments disclosed in the present specification, the nonaqueous electrolyte battery 3 (FIG. 8), the nonaqueous electrolyte battery 2 (FIG. 7), the nonaqueous electrolyte battery 1 (FIG. 3), the nonaqueous electrolyte battery 6 (FIG. 11), the nonaqueous electrolyte battery 5 (FIG. 10), and the nonaqueous electrolyte battery 4 (FIG. 9) are more preferable in this order.

### Other Embodiments

Though the embodiments of the present invention have been discussed above, the present invention is not limited to the above-discussed embodiments, but allows various variations.

As shown in the nonaqueous electrolyte batteries 1 to 6, in the nonaqueous electrolyte battery in accordance with the present invention, the winding trailing end portion (311b, 612b) of one of the positive electrode mixture layers has only to be positioned on the inner side of the winding body with respect to the negative electrode tab in the width direction of the winding body and the winding trailing end portion (312b, 611b) of the other positive electrode mixture layer has only to be positioned on the outer side of the winding body with respect to the negative electrode tab in the width direction of the winding body. This is because it is thereby possible to disperse the level differences at the winding trailing end portions.

In the above-discussed structure, as shown in the nonaqueous electrolyte batteries 1 to 3, it is preferable that the winding trailing end portion (312b) of the positive electrode mixture layer which is positioned on the outer side of the winding body with respect to the negative electrode tab should be positioned on the outer side of the winding body with respect to the winding trailing end portion (311b) of the other positive electrode mixture layer in the width direction of the winding body. This is because there arises no bent portion in the positive electrode mixture layer on the outer side.

In the above-discussed structure, as shown in the nonaqueous electrolyte batteries 2, 3, 5, and 6, it is preferable that the winding trailing end portion (421b, 521b, 722b, 822b) of one of the negative electrode mixture layers is positioned between the winding trailing end portion of the positive electrode mixture layer opposed thereto and the positive electrode tab and not positioned between both the end portions of the negative electrode tab in the width direction of the winding body and the winding trailing end portion (422b, 522b, 721b, 821b) of the other negative electrode mixture layer is positioned between the winding trailing end portion of the positive electrode mixture layer opposed thereto and the positive electrode tab in the width direction of the winding body. This is because it is possible to prevent the torsion of the negative electrode tab with the difference in expansion between both the winding trailing end portions of the negative electrode mixture layers.

In the above-discussed structure, as shown in the nonaqueous electrolyte batteries 3 and 6, it is preferable that both the winding trailing end portions are positioned between the positive electrode tab and the negative electrode tab in the width direction. This is because the thickness of the thickest portion of the winding body can be thinned.

This specification shows the exemplary structure in which the positive electrode tab is formed on the outermost side of the winding body. The positive electrode tab, however, may be formed on the innermost side of the winding body (on the side of the winding leading end portion of the positive electrode).

This specification shows the exemplary structure in which the winding body is contained in the battery case consisting of the exterior can and the cover plate which are formed of, e.g., an aluminum alloy or the like. The present invention is not limited to this structure, but there may be another structure in which the winding body is contained in a laminate outer package or the like.

This specification shows the exemplary case where the nonaqueous electrolyte battery is a lithium-ion secondary battery. The present invention can be preferably utilized particularly in the case where the nonaqueous electrolyte battery is a lithium-ion secondary battery. The present invention, however, is not limited to this case, but the present invention can be utilized as various kinds of nonaqueous electrolyte batteries within the scope of an investigation.

### EXAMPLES

Hereinafter, the present invention will be discussed more specifically on the basis of Example. This Example does not limit the present invention.

### Example

<Production of Positive Electrode>

100 parts by mass of a positive electrode active material in which Li_{1.0}Ni_{0.5}Co_{0.2}Mn_{0.3}O₂ and Li_{1.036}Co_{0.0991}Al_{0.004}Mg_{0.002}Sr_{0.001}Ti_{0.002}Zr_{0.001}O₂ are mixed in the proportion of 3:7 (mass ratio), 20 parts by mass of a N-Methyl-2-pyrrolidone (NMP) solution containing 10% by mass of PVDF serving as a binder, 1 parts by mass of artificial graphite serving as an electroconductive aid, and 1 parts by mass of Ketjen Black are kneaded by using a biaxial kneading machine and NMP is further added thereto for adjustment of viscosity, to thereby prepare a positive electrode mixture-containing paste.

After applying the positive electrode mixture-containing paste (slurry) onto both surfaces of an aluminum foil (positive electrode current collector) having a thickness of 15 μm, the aluminum foil is dried in a vacuum at 100° C. for seven hours, to thereby form the positive electrode mixture layers on both the surfaces of the aluminum foil. After that, a press (calendering) process is performed to thereby adjust the thickness and the density of the positive electrode mixture layer, and a positive electrode tab made of nickel is welded to an exposed portion of the aluminum foil, to thereby produce a strip-like positive electrode having a length of 543 mm and a width of 50 mm. The positive electrode mixture layer for each side in the produced positive electrode has a thickness of 65 mm.

<Production of Negative Electrode>

97.5 parts by mass of a mixture, serving as a negative electrode active material, in which a complex in which an SiO surface having an average particle diameter D50% of 8 μm is coated with a carbon material (the amount of the carbon material is 10% by mass in the complex) and graphite having an average particle diameter D50% of 16 μm are mixed so that the amount of the complex in which the SiO surface is coated with the carbon material is 3.75% by mass, 1.5 parts by mass of SBR serving as a binder, and 1 part by mass of CMC serving as a thickener are mixed with water added thereto, to thereby prepare a negative electrode mixture-containing paste.

After applying the negative electrode mixture-containing paste (slurry) onto both surfaces of a copper foil (negative electrode current collector) having a thickness of 8 μm, the copper foil is dried in a vacuum at 160° C. for twenty-four hours, to thereby form the negative electrode mixture layers on both the surfaces of the copper foil. After that, a press (calendering) process is performed to thereby adjust the thickness and the density of the negative electrode mixture layer, and a negative electrode tab made of nickel is welded to an exposed portion of the copper foil, to thereby produce a strip-like negative electrode having a length of 626 mm and a width of 51 mm. The negative electrode mixture layer for each side in the produced negative electrode has a thickness of 60 μm.

<Preparation of Nonaqueous Electrolyte Solution>

LiPf₆ is dissolved in a mixed solvent in which ethylene carbonate (EC) and diethyl carbonate (DEC) are mixed in the proportion of 3:7 (volume ratio) at a concentration of 1.1 mol/L, and 2.0% by mass of fluoroethylene carbonate (FEC) and 2.0% by mass of vinylene carbonate (VC) are added thereto, to thereby prepare a nonaqueous electrolyte solution.

<Assembly of Battery>

The strip-like positive electrode is superposed on the strip-like negative electrode with a PE separator having a thickness of 16 μm for lithium-ion secondary battery interposed therebetween and the layered body is wound, and then pressure is imposed thereon to make the layered body into a flattened shape. The winding body is so produced as to have a structure in conformance with that of the winding body 30 (FIG. 3) in accordance with the first embodiment.

Next, the electrode winding body is inserted into a square battery case made of an aluminum alloy having an external thickness of 4.4 mm, an external width of 45.8 mm, and an external height of 55.3 mm, a current collector tab is welded thereto, and a cover plate made of an aluminum alloy is welded to an opening end portion of the battery case. Then, the nonaqueous electrolyte solution is injected from an inlet provided in the cover plate, and after still standing for one hour, the inlet is sealed. After that, through a chemical conversion treatment, a lithium-ion secondary battery having such a structure as shown in FIG. 1 is achieved.

### Comparative Example

Herein, a winding body is so produced as to have a structure in conformance with the winding body 90 (FIG. 5) of the comparative embodiment. A lithium-ion secondary battery in which constituent elements other than the above are identical to those in Example is used in Comparative Example.

<Expansion Measurement>

As a thickness meter, used is Digital Micrometer (manufactured by Mitutoyo Corporation). Thickness measurement is performed at a measuring pressure of 5 to 10 N by using a measuring terminal of φ6 mm on ten batteries manufactured in each of Example and Comparative Example.

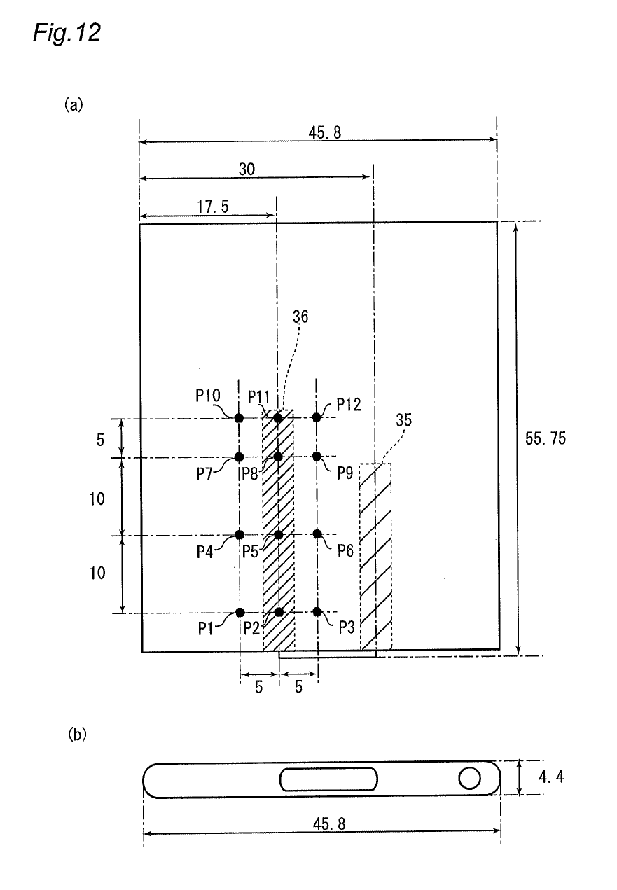

FIG. 12 is a view showing thickness measurement points in an expansion measurement. FIG. 12(a) is an elevational view of a lithium-ion secondary battery, and FIG. 12(b) is a plan view thereof, with dimensions. In FIG. 12(a), the respective positions of the positive electrode tab 35 and the negative electrode tab 36 are hatched and schematically shown. For each battery, the thickness is measured at twelve points (P1 to P12) in the vicinity of the negative electrode tab 36 before and after the chemical conversion treatment. The thickness of each point is measured five times, and an average value is obtained. At a point which has the largest difference in thickness between before and after the chemical conversion treatment, the difference in thickness between before and after the chemical conversion treatment (the amount of expansion) is checked.

For each of ten batteries manufactured in Example, the amount of expansion (mm) is obtained in the above-discussed manner and an average value is calculated. Also for each of ten batteries manufactured in Comparative Example, the amount of expansion (mm) is obtained in the above-discussed manner and an average value is calculated. The result is shown in Table 1.

TABLE 1

| | Amount of Expansion (mm) |
|---|---|
| Example | 0.287 |
| Comparative Example | 0.314 |

As shown in Table 1, the amount of expansion in the lithium-ion secondary battery in Example is smaller than that in the lithium-ion secondary battery in Comparative Example. It can be thought that by the present invention, the winding body can be uniformly expanded and this prevents undulation.

### INDUSTRIAL APPLICABILITY

The present invention can be industrially used as a nonaqueous electrolyte battery comprising a flattened winding body.

1-7. (canceled)

8. A nonaqueous electrolyte battery comprising:
a winding body having a flattened shape, in which a positive electrode and a negative electrode are wound with a separator interposed therebetween; and
a negative electrode tab joined to said negative electrode, extending in a winding axis direction of said winding body,
wherein said positive electrode includes a positive electrode current collector having a strip-like shape, a first positive electrode mixture layer formed on one surface of said positive electrode current collector, and a second positive electrode mixture layer formed on the other surface of said positive electrode current collector,
a direction parallel to a main surface of said winding body and perpendicular to the winding axis direction is assumed to be a width direction,
a winding trailing end portion of said first positive electrode mixture layer is positioned on an inner side of said winding body with respect to said negative electrode tab in said width direction, and
a winding trailing end portion of said second positive electrode mixture layer is positioned on an outer side of said winding body with respect to said negative electrode tab in said width direction.

9. The nonaqueous electrolyte battery according to claim 8, wherein
the winding trailing end portion of said second positive electrode mixture layer is positioned on an outer side of said winding body with respect to the winding trailing end portion of said first positive electrode mixture layer.

10. The nonaqueous electrolyte battery according to claim 9, further comprising:
a positive electrode tab joined to said positive electrode, extending in the winding axis direction of said winding body,
wherein said negative electrode includes a negative electrode current collector having a strip-like shape, a first negative electrode mixture layer which is so formed on one surface of said negative electrode current collector as to be opposed to said second positive electrode mixture layer with said separator interposed therebetween, and a second negative electrode mixture layer formed on the other surface of said negative electrode current collector,
a winding trailing end portion of said first negative electrode mixture layer is positioned between the winding trailing end portion of said second positive electrode mixture layer and said positive electrode tab and not positioned between both ends of said negative electrode tab in said width direction, and
a winding trailing end portion of said second negative electrode mixture layer is positioned between the winding trailing end portion of said first positive electrode mixture layer and said positive electrode tab in said width direction.

11. The nonaqueous electrolyte battery according to claim 8, further comprising:
a positive electrode tab joined to said positive electrode, extending in the winding axis direction of said winding body,
wherein said negative electrode includes a negative electrode current collector having a strip-like shape, a first negative electrode mixture layer which is so formed on one surface of said negative electrode current collector as to be opposed to said second positive electrode mixture layer with said separator interposed therebetween, and a second negative electrode mixture layer formed on the other surface of said negative electrode current collector,
a winding trailing end portion of said first negative electrode mixture layer is positioned between the winding trailing end portion of said second positive electrode mixture layer and said positive electrode tab and not positioned between both ends of said negative electrode tab in said width direction, and
a winding trailing end portion of said second negative electrode mixture layer is positioned between the winding trailing end portion of said first positive electrode mixture layer and said positive electrode tab in said width direction.

12. The nonaqueous electrolyte battery according to claim 11, wherein
the winding trailing end portion of said first negative electrode mixture layer is positioned between said positive electrode tab and said negative electrode tab in said width direction.

13. The nonaqueous electrolyte battery according to claim 10, wherein
the winding trailing end portion of said first negative electrode mixture layer is positioned between said positive electrode tab and said negative electrode tab in said width direction.

14. The nonaqueous electrolyte battery according to claim 8, wherein
said negative electrode tab has one end which is so formed as to be positioned in the vicinity of one end portion of said negative electrode in the winding axis direction and the other end which is so formed as to protrude from the other end portion of said negative electrode in the winding axis direction.

15. The nonaqueous electrolyte battery according to claim 8, wherein
said negative electrode tab is joined to said negative electrode only at the vicinity of both end portions of said negative electrode in the winding axis direction and a center portion thereof is not joined.

16. The nonaqueous electrolyte battery according to claim 11, wherein
said first and second negative electrode mixture layers contain a metal or an oxide.

17. The nonaqueous electrolyte battery according to claim 10, wherein
said first and second negative electrode mixture layers contain a metal or an oxide.
